(19) United States
(12) Patent Application Publication
(10) Pub. No.: US 2024/0135209 A1
(43) Pub. Date: Apr. 25, 2024

(54) DATA PRIVACY PRESERVATION IN MACHINE LEARNING TRAINING

(71) Applicant: Intel Corporation, Santa Clara, CA (US)

(72) Inventors: Priyanka Mudgal, Portland, OR (US); Rita H. Wouhaybi, Portland, OR (US)

(73) Assignee: Intel Corporation, Santa Clara, CA (US)

(21) Appl. No.: 18/400,632

(22) Filed: Dec. 29, 2023

(51) Int. Cl. G06N 5/04; G06N 20/00

(52) U.S. Cl. CPC G06N 5/04; G06N 20/00

(57) ABSTRACT

A first computing system includes a data store with a sensitive dataset. The first computing system uses a feature extraction tool to perform a statistical analysis of the dataset to generate feature description data to describe a set of features within the dataset. A second computing system is coupled to the first computing system and does not have access to the dataset. The second computing system uses a data synthesizer to receive the feature description data and generate a synthetic dataset that models the dataset and includes the set of features. The second computing system trains a machine learning model with the synthetic data set and provides the trained machine learning model to the first computing system for use with data from the data store as an input.

### TECHNICAL FIELD

This disclosure relates in general to the field of computer networking, and more particularly, though not exclusively, to developing machine learning models trained on synthetic data.

### BACKGROUND

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

Edge computing may, in some scenarios, offer or host a cloud-like distributed service, to offer orchestration and management for applications, coordinated service instances and machine learning, such as federated machine learning, among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an overview of an Edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates a block diagram for an example edge computing device.

FIG. 5 illustrates an overview of layers of distributed compute deployed among an edge computing system.

FIGS. 6A-6B are simplified block diagrams of an example system for training a machine learning model.

FIG. 7 is a simplified block diagram showing a flow of operations and data in the training of a machine learning model using synthetic training data.

FIG. 8 is a simplified flow diagram illustrating example techniques of a provider system.

FIG. 9 is a simplified flow diagram illustrating example techniques of a customer system.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

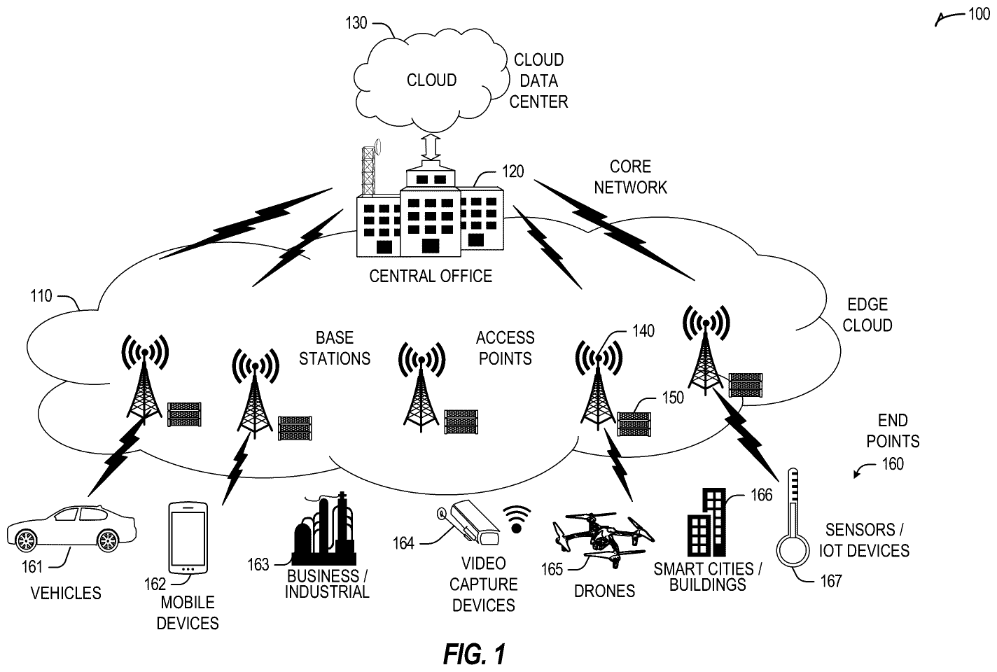

FIG. 1 is a block diagram 100 showing an overview of a configuration for edge computing, which includes a layer of processing referred to in many of the following examples as an “edge cloud” or “edge system”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 may be leveraged to provide ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the resources needed for network services, through the distribution of more resources which are located closer both geographically and in network access time. In this manner, edge computing attempts to bring the compute resources to the workload data where appropriate, or bring the workload data to the compute resources.

Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services where the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

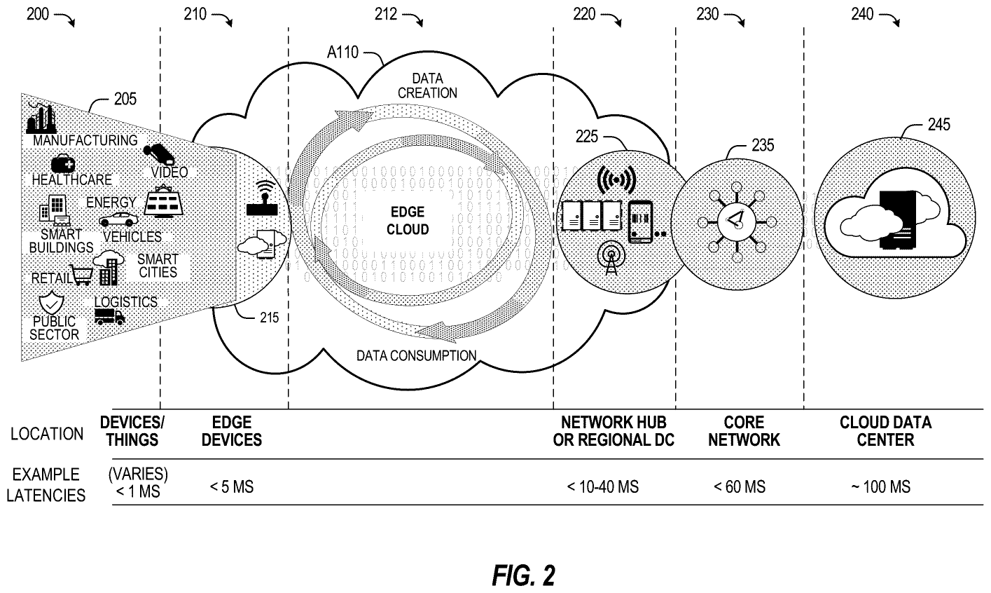

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following traditional caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues may be magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

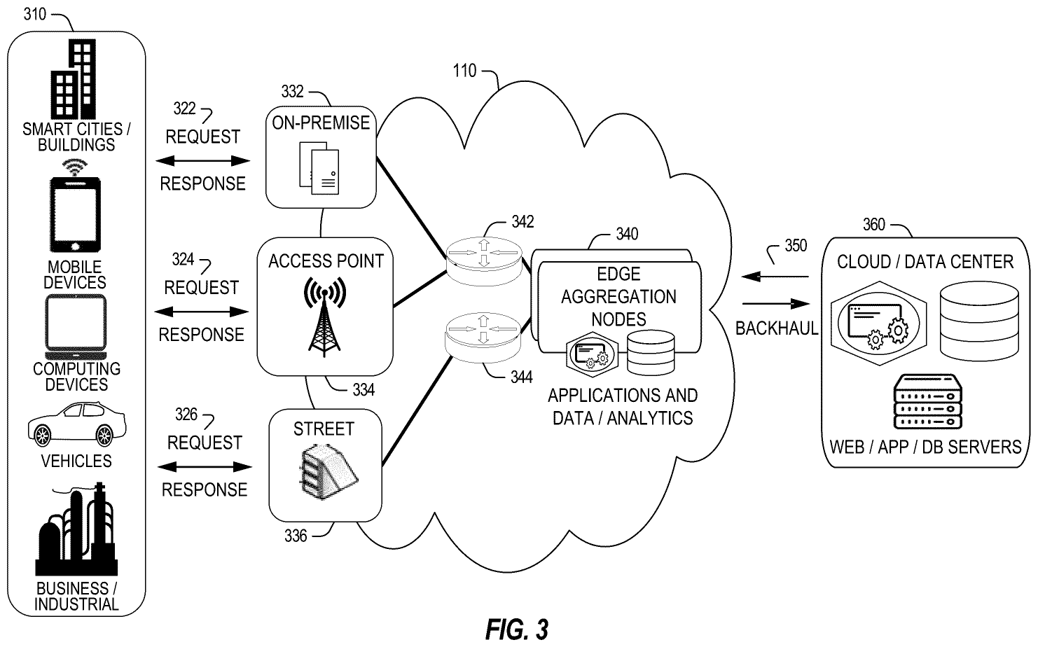

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

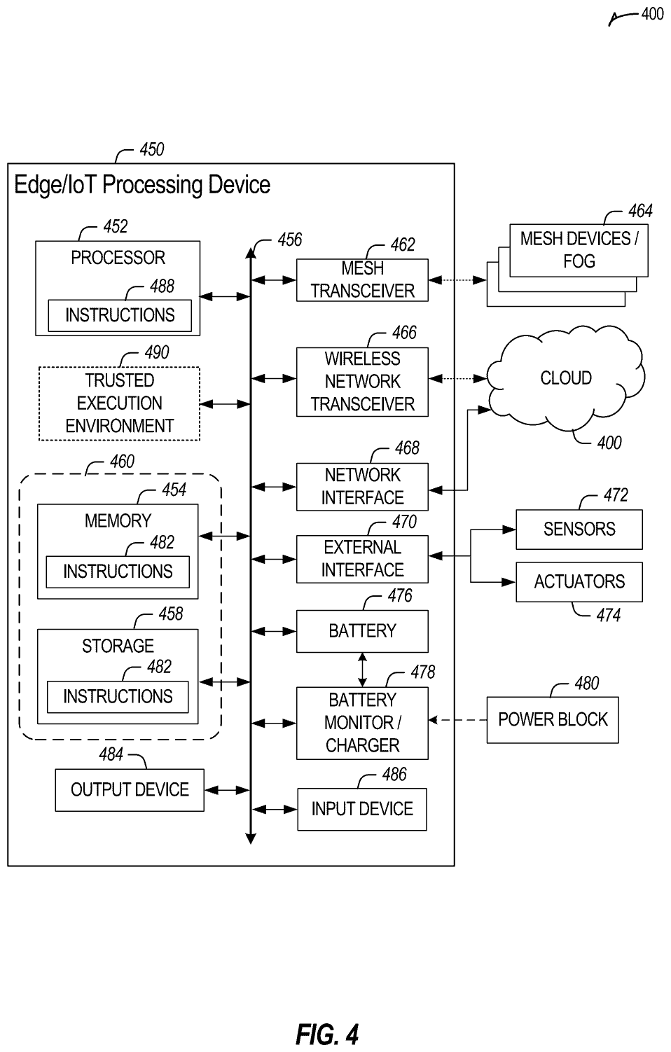

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Additionally, the block diagram of FIG. 4 is intended to depict a high-level view of components of the edge device 450. However, some of the components shown may be omitted, additional components may be present, and different arrangement of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, xD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 456 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensor, pressure sensors, barometric pressure sensors, and the like. The external interface 470 further may be used to connect the edge device 450 to actuators 474, such as power switches, valve actuators, an audible sound generator, a visual warning device, and the like.

In some optional examples, various input/output (I/O) devices may be present within, or connected to, the edge device 450. Further, some edge computing devices may be battery powered and include one or more batteries (e.g., 476) to power the device. In such instances, a battery monitor/charger 478 may be included in the edge device 450 to track the state of charge (SoCh) of the battery 476. The battery monitor/charger 478 may be used to monitor other parameters of the battery 476 to provide failure predictions, such as the state of health (SoH) and the state of function (SoF) of the battery 476, which may trigger an edge system to attempt to provision other hardware (e.g., in the edge cloud or a nearby cloud system) to supplement or replace a device whose power is failing, among other example uses. In some instances, the device 450 may also or instead include a power block 480, or other power supply coupled to a grid, may be coupled with the battery monitor/charger 478 to charge the battery 476. In some examples, the power block 480 may be replaced with a wireless power receiver to obtain the power wirelessly, for example, through a loop antenna in the edge device 450, among other examples.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

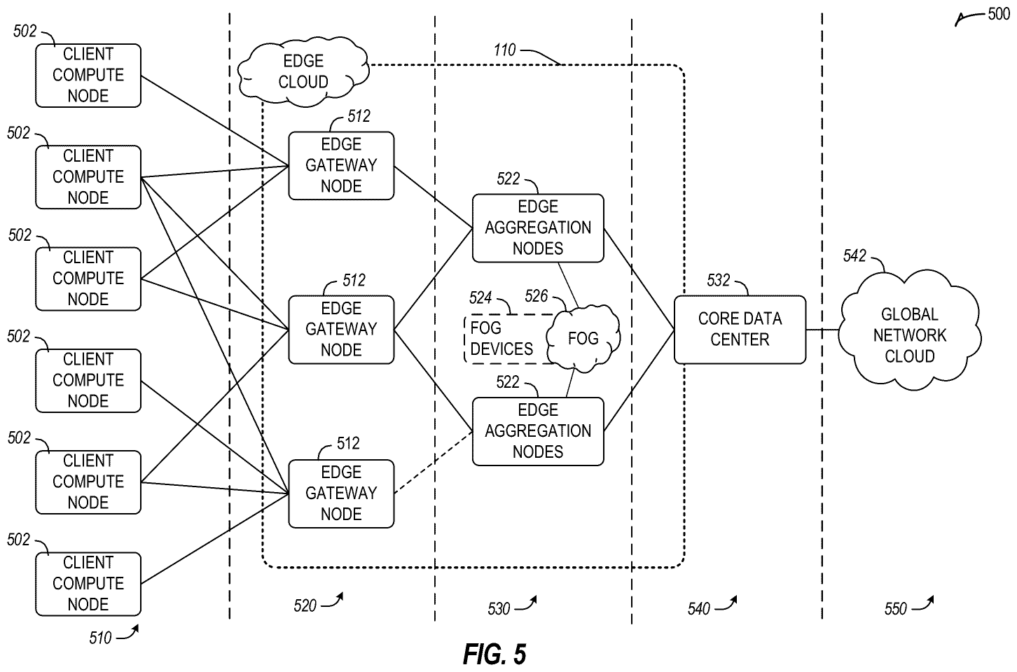

At a more generic level, an edge computing system may be described to encompass any number of deployments operating in an edge cloud 110, which provide coordination from client and distributed computing devices. FIG. 5 provides a further abstracted overview of layers of distributed compute deployed among an edge computing environment for purposes of illustration. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 532 may be located within, at, or near the edge cloud 110.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

Consistent with the examples provided herein, each client compute node 502 may be embodied as any type of end point component, device, appliance, or “thing” capable of communicating as a producer or consumer of data. Further, the label “node” or “device” as used in the edge computing system 500. As such, the edge cloud 110 is formed from network components and functional features operated by and within the edge gateway nodes 512 and the edge aggregation nodes 522 of layers 520, 530, respectively. The edge cloud 110 may be embodied as any type of network that provides edge computing and/or storage resources which are proximately located to radio access network (RAN) capable endpoint devices (e.g., mobile computing devices, IoT devices, smart devices, etc.), which are shown in FIG. 5 as the client compute nodes 502. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 110 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

Edge computing systems, such as introduced above, may be utilized to provide hardware and logic to implement various applications and services, including machine learning and artificial intelligence applications. The development and application of artificial intelligence (AI)- and machine learning-based solutions are growing at an unprecedented rate. From generative AI solutions (e.g., large language models, ChatGPT™, chat bots, Bard, Gemini, Grok, etc.) to self-driving cars and robotics, AI is becoming pervasive. The algorithms and models that drive AI and machine learning solutions generally rely on extensive training using large and, in some cases, continuously evolving data sets so as to acquire the “intelligence” that makes these solutions so useful. However, in recent years, controversies and regulations have emerged based on objections from the owners and creators of data used in machine learning training data. Such objections include privacy objections, confidentiality objections, intellectual property rights objections, cultural objections, among other example issues. Indeed, in many domains people, governments, non-profit entities, and businesses have voiced concern about issues associated with the sharing and use of data in the training and development of machine learning models. The availability of accurate, complete, and up-to-date data is critical, however, in training machine learning models with the best and most relevant intelligence. If data owners are hesitant to release or allow the use of their data to train machine learning algorithms, it can be expected that the accuracy and evolution of machine learning solutions will likewise suffer.

In an attempt to address some of the issues surrounding the use of privately owned data in the training of machine learning and AI models, innovation has begun around developing AI training solutions where very little data is used (e.g., forecasting, anomaly detection, etc.), but to date these approaches often falls short in delivering models with the features or accuracy demanded in several applications and industries. For instance, lightweight training may be insufficient for use cases where a more intimate or detailed knowledge of the data is critical to the application. As illustrative examples, more specific data may be required to develop AI solutions in industries such as prospecting in the oil and gas and mining sectors (e.g., predictive maintenance for the drilling machinery in remote locations) or for tools relating to the discovery of specific compounds for use in the pharmaceutical or medical fields, among other examples.

Where the depth and quality of training data cannot be realistically sacrificed or abridged, other solutions are being developed to address the concerns of data owners. As one example, federated learning has emerged as a solution, for instance, where different parties agree to share their data with an escrow service or independent third party. In a federated learning solution offer, multiple entities share instances of a model trained with their data with a centralized account or server, which may act to share a final model based on these contributed models among different machines in the same network. The trained models shared from the multiple entities incorporate the previous knowledge built in them by training on the private datasets of these entities. Within some contexts however, this may represent an acceptable risk to the entity's intellectual property embodied within their data. In other words, while federated learning may succeed in protecting the privacy of the data itself, such solutions may still expose the underlying intellectual property and other competitive advantages inherently included with the entity's data to the other data owners involved in the federated learning. For instance, to train a particular model using federated learning, multiple parties may agree to pool their resources to train a machine learning model using their respective data. However, parties whose data is “stronger” in that it represents more complete or unique practices, processes, customers, or machinery may get less from the federated learning “bargain” than other participants who are behind this entity in their own practices, processes, customers, or machinery, among other issues. Accordingly, owners of higher-tier data may have more to lose than gain by pooling with lower quality datasets in a federated learning solution, because if a model trained through federated learning is used for another customer's (or, worse, a competitor's) inference, the model is intrinsically using pre-built knowledge from other participants and giving this benefit to the next customer. This leads to a violation of intellectual property and gives a lead to other customers in the field. While federated learning may be a great solution in some domains such as medical diagnosis recommendations, public works, or law enforcement, it may be unacceptable to other domains, particularly in the commercial, industrial, or other private sector markets.

In an improved system, an AI learning system may be implemented to train an AI model tuned to a particular customer's use case and trained using the data of the customer, but without the customer needing to share their data with a third party, including an entity (e.g., data scientists, AI developers, etc.), much less pooling their sensitive data with that of their competitors. Outside of an exclusively in-house model design and training process, which may be unrealistic to most companies, there are little to no techniques that can support machine learning model training without sharing the dataset. The closest solutions that industries can use is federated learning. In the improved solution introduced herein, synthetic data may be generated from the low dimensional statistical features of customer data and used to train a given machine learning model to the specific needs of the data owner, all while protecting the intellectual property and competitive advantages of the customer, among other example advantages. In some examples of synthetic data generation, sensitive or private information is omitted or anonymized (e.g., names are redacted or replaced with non-matching random names or residential addresses are redacted or reduced to just a zip code, state, or region, among other examples).

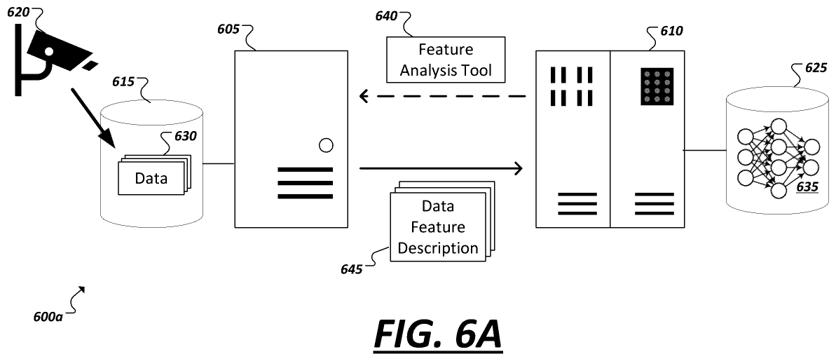

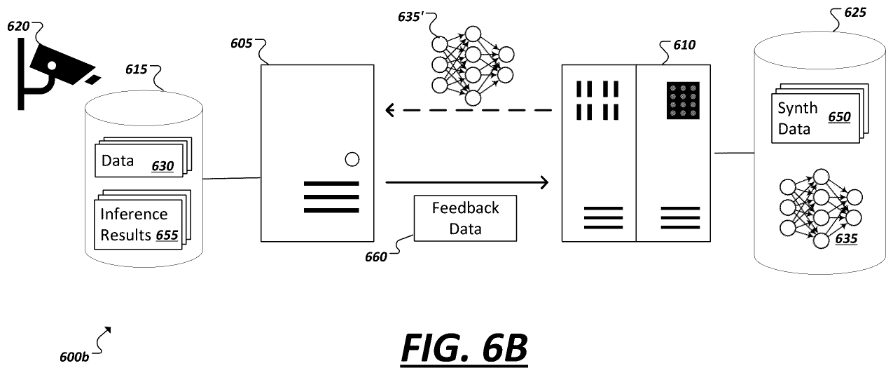

In one example implementation, a system is provided where a first entity is enabled to train machine learning models on behalf of a second entity without requiring the second entity to share any of their (e.g., proprietary) datasets. Turning to the simplified block diagrams 600a-b of FIGS. 6A-6B, an example system is presented including a computing system 605 of the second entity, or a “customer” entity, and a computing system 610 of the first entity, or a “provider” entity. The customer computing system 605 may include a variety of sensors (e.g., 620), devices, users, or other entities used to create internal data 630, which the customer may use for a variety of purposes, and which the customer takes precautions to safeguard and keep private. Accordingly, the customer system may include one or more internal, protected, or otherwise secured data stores (e.g., 615) to protect and guard access to their data 630. The provider entity may specialize in or otherwise provide services relating to the development and/or training of machine learning models (e.g., 635). For instance, the mechanisms and processes by which the provider entity develops and trains machine learning mo615desl (e.g., for itself or its customers) may likewise represent sensitive intellectual property (e.g., with such data being stored in one or more data stores (e.g., 625) owned or controlled by the provider entity).

In one example implementation, the customer system and provider system may communicate over one or more wired or wireless networks (e.g., over secured communication channels). It may be the desire of a customer to acquire a machine learning model for deployment on their systems, which is trained to fit the specific activities and data of the customer. However, the customer may not want to share its proprietary or sensitive internal data 630 with the provider entity (or any third party). In one example implementation, to assist in implementing a protected machine learning (ML) model training (e.g., without the use of the customer's actual data), a feature analysis tool 640 (e.g., implemented as a piece of code, a script, a utility program, or application) may be accessed by the customer system 605. In some cases, the feature analysis tool 640 may be developed by and tuned to the processes of the provider system 610 and provided by the provider system to the customer system 605. The feature analysis tool 640 may be executed within the customer's own system 605 to take, as an input, datasets (e.g., 630) of the customer, to analyze the customer's data to detect features and patterns appearing (e.g., with statistical significance) within the customer data. As an output, the feature analysis tool 640 may generate data feature description(s) 645, which describe features (e.g., entities, patterns, etc.) detected within the data. The data feature description may otherwise obscure the contents of the customer data 630. This data feature description data 645 may be provided to the provider system 610 in place of the customer's actual data 630 for use by the provider system 610 in training one or more machine learning models (e.g., 635) on behalf of the customer. In this manner, the customer data 630 remains secured and the underlying intellectual property is preserved.

Turning to FIG. 6B, the provider system 610 may receive the data feature description data 645 generated by the feature analysis tool 640 on the customer system 605 and may take this data feature description data 645 as an input to generate a synthetic dataset 650 from the features and characteristics described in the data feature description data 645. The synthetic dataset 650 may represent an approximation or virtualization of the actual customer 630, which is kept from being accessed directly. The provider system 610 uses the synthetic data set 650 to train one or more machine learning models or AI algorithms (e.g., 635) (collectively referred to herein as “machine learning models” or “ML models”) and sends the trained ML model 635′ with the customer system 605. The customer system 605 may deploy this trained model 635′ and test its accuracy by applying real data from the customer (e.g., 630) to determine if the inferences or predictions output by the ML model are accurate or not. The customer system may generate feedback data 660 describing the results of the testing, which the provider system 610 may use to refine or generate new synthetic data 650 for a retraining of the ML model 635 or to modify the ML model 635 itself, if the results of the testing showed that the accuracy or utility of the trained ML model 635′ was below acceptable standards. Accordingly, multiple iterations of synthetic data generation/refinement may be performed, together with retraining of a ML model (e.g., 635) until the customer determines that the trained model functions as intended (e.g., resulting in accurate inference or prediction results when deployed in the customer system against real data).

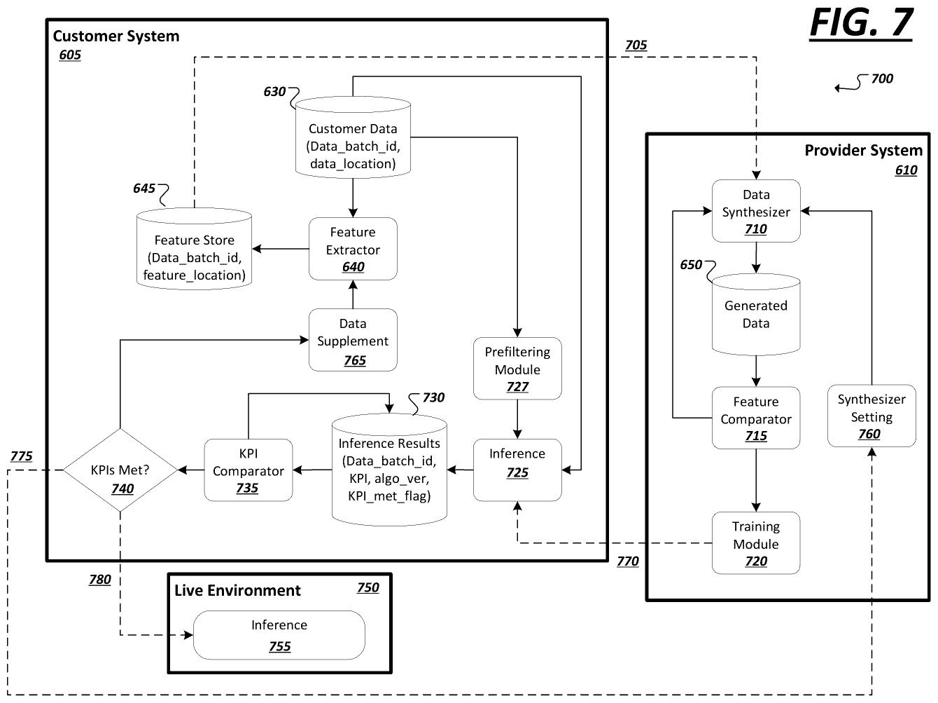

Turning to FIG. 7, a simplified block diagram 700 is shown illustrating the flow within an architecture including a customer system and a provider system 610 in accordance with one example. Using such an architecture, an AI algorithm or machine learning model may be trained without customers sharing their data with the model programmer or trainer, allowing AI solutions to be scaled without traditional federated learning or sharing data on the cloud, or another similar approach. In this example, a customer may generate a variety of data 630 through sensors deployed, for instance, on the customer site(s) and collecting information in connection with the customer's activities. As an example, a customer may be a retail company with one or more physical retail locations and cameras collecting video streams or digital photo data in connection with store security, inventory management, self-check-out systems, or other examples. Customer data 630, depending on the nature and activities of the customer entity may embody a variety of different data types and information (e.g., time series data, image data, sensor data streams sensing temperature, pressure, speed, etc.).

As in the example of FIG. 6, a customer system 605 may execute a feature analysis tool (or feature extractor) 640 to analyze the customer data 630 locally or otherwise within the customer system domain 605, without exposing the customer data 630 to a third party, and generate feature description data 645. The feature analysis tool 640 can process data sets (e.g., 630) of the customer system 605 to identify trends or patterns within the data that may (or may not) be consequential from a model training perspective, but appear in statistically significant ways. The nature of such trends or patterns may be based on the type of data and the activities of the customer. In some implementations, the customer data 630 may include labeled data (e.g., labeled by a subject matter expert of the customer) to assist in the feature extraction. In other cases, unsupervised learning models may be employed by the feature analysis tool and unlabeled data (e.g., 630) may be fed to the feature analysis tool from which feature description data 645 is generated, among other example implementations.

In one illustrative example, in the case of time series data, the feature analysis tool 640 may detect features on the basis of one or a combination of the mean, media, standard deviation, root mean square, minimums, maximum, absolute maximum, etc. In the case of image or video data, the feature analysis tool 640 may detect edges, regions of interest, movement, gestures, gait, ridges, color blocks, among other examples. Descriptions of the detected features, as well as the relative frequency of their appearance in the underlying customer data, together with any customer-supplied metadata (e.g., label data, time stamp data, etc.), may be incorporated in feature description data 645 generated by the feature analysis tool 640. This data is then shared (at 705) with the provider system 610.

The provider system 610 may accept the provided feature description data 645 in association with the training of a particular machine learning model requested by the customer. The provider system 610 may include a data synthesizer 710. The data synthesizer 710 generates a synthetic dataset 650 from the feature description data 645 that maintains the same or similar characteristics and features in the customer data set 630. In one example implementation, the data synthesizer 710 includes a generative AI algorithm (e.g., based on a generative adversarial network (GAN) model, among other examples) with predefined weights configured to generate a synthetic training data set from the feature description data 645 input. The weights of the data synthesizer model 710 may be adjustable, for instance, based on feedback received from the customer system (e.g., at 740) or in response to other quality checks that may be performed on the prober system. In one implementation, the data synthesizer 710 may include or be provided with multiple hyperparameters to direct the manner in which the synthetic data set 650 is to be generated. For instance, hyperparameters may include target data, size, start value, end value, among other examples.

The synthetic data 650 generated by the data synthesizer 710 may be maintained within the provider system. Assuming that the feature description data 645 does an accurate job describing the features occurring within the customer data 630, the resulting synthetic data 650 should correlate well with the original data 630. To check the quality of the synthetic data 650, in some implementations, feature comparator logic 715 may be provided within the provider system 610 to compare the input features described in the received feature description data 645 with the generated dataset's 650 features. The feature comparator 715 may be implemented as software code, which parses the feature description data 645 to identify the features that are to occur in the generated synthetic data set 650 and scans the synthetic data set 650 to identify instances and check the accuracy of these features as they occur in the generated synthetic data 650. If the features do not match, then the weights of the data synthesizer 710, for instance, may be adjusted (e.g., an iterative manner) to generate a replacement version of the synthetic dataset 650. This process may continue and iterate until the features detected in the synthetic data 650 (by the feature comparator 715) are within a threshold margin of divergence from the ground truth features as defined in the feature description data 645. In one example, the feature comparator may utilize a particular correlation coefficient (e.g., spearman correlation coefficient, Pearson correlation coefficient, etc.) in its comparisons of feature definitions to features in the synthetic datasets 650, among other example techniques.

Continuing with the example of FIG. 7, the provider system 610, upon generating an acceptable (e.g., as determined from the check(s) provided by the feature comparator block 715) synthetic data set 650 to mimic the actual dataset 630 of the customer system 605, may use the synthetic data set 650 to train one or more particular machine learning model(s) (e.g., as requested of the provider system 610 by the customer system 605 (e.g., in association with the provision of feature description data 645). For instance, the provider system 610 may include a training module 720, which is adapted to use real or synthetic data to train ML models. In this example, the training module 720 uses the synthetic dataset 650 to train a predicted AI/ML model (e.g., for anomaly detection, forecasting, classification, among other example uses). The training may be deemed complete by the training module, once the ML model performs satisfactorily (using the synthetic data 650), for instance, in terms of defined key performance indicators (KPIs), thresholds, or other conditions defined for the model (e.g., root mean square error (RMSE), mean absolute percentage error (MAPE), accuracy, etc. Once trained on the synthetic data 650, the provider system 610 provides the trained model (at 770) to the customer system 605.

The customer system 605 may test the trained ML model using its internal inference engine 725, which may launch and use the trained ML model with inputs from the customer system's own “real” data (e.g., 630) to identify and measure how the trained ML model performs. Allowing the inference to occur on the customer system 605 further serves to preserve data privacy. Customer data 630 fed as inputs to the trained ML model may be fed as chunks, in multiple N batches, etc. The results of the inference 730 may be collected and stored in the customer system 605. To test the accuracy and performance of the trained ML model, a KPI comparator block 735 may be provided on the customer system and executed to access the inference result data 730 and determine (e.g., for each one of a set of KPIs used to assess the ML model's accuracy and performance) the accuracy of the inferences (as identified in the inference result data 730). The KPI comparator 735, in some implementations, may tag or label inference result data to identify which (if any) KPIs are met for each of the inference results generated during the inferences run using the trained ML model.

In some implementations, to enhance testing of a trained ML model received from a provider system 610 and trained using synthetic training data (e.g., 650), the customer system 605 may include and use a prefiltering module 727. The prefiltering module 727, in one example, may filter customer data 630 used in the inferences to focus on features included in the customer data (e.g., sending only segments of the overall data based on those segments including features of interest or described in feature description data, etc.), to ensure that these features are properly assessed during the inference testing. This pre-filtering may be applied to the customer data 630 before feeding into the inference model. In other implementations, unfiltered customer data 630 may be instead (or additionally) provided to the inference model (e.g., by bypassing the prefiltering module 727), among other example features.

The KPI comparator 735 may compare inference results with the ground truth and determine KPI measurements based on this comparison. In some instances, subject matter experts associated with the customer entity may provide inputs to define the KPIs and what conditions satisfy a KPI being met (e.g., as processed using the KPI comparator). The KPI may be accuracy, MSE, RMSE, etc. depending on the task. For example, MSE may be measured in the case of anomaly detection, accuracy can be measured for classification, and MAPE in the case of forecasting, among other examples. If inference results fall short of the KPIs thresholds (e.g., determined and enforced in the customer system 605), the customer system 605 may initiate actions to attempt to improve subsequent versions of the ML model as generated and trained using the provider system 610. In some cases, the customer system 605 may generate feedback data from the KPI comparator results and provide this feedback information (e.g., at 775) to the provider system 610. This feedback information may be utilized (e.g., by a synthesizer setting module 760) to adjust settings (e.g., weights, learning rate, etc.) of the data synthesizer based on the feedback information (e.g., to better or more accurately represent some of the features described in the original feature description data provided by the customer system 605. Alternatively or additionally, the customer system may select the subset of customer data used in inferences where the KPI's were not met in the inference result data 730 and provide a description of this information as supplemental data 765 to provide to the feature extractor to generate supplemental or new feature description data 645, that should also be provided to the provider system 610 to be considered and used by the data synthesizer, such that subsequent versions of the synthetic training data 650 generated by the data synthesizer 710 is improved, by incorporating these features (e.g., that may have previously not been included or adequately described in the first version of the feature description data provided from the customer system 605).

The adjustment of settings and/or additional feature description data may be used by the data synthesizer to generate a new version of the synthetic data 650 representing the customer data or alternatively generate supplemental data to be added to the original version of the synthetic data that incorporates the features that were missing or inadequately described in the first version of the feature description data, among other examples. This new synthetic data may be used to further train or re-train the ML model (using training module 720) to generate a second iteration of the trained ML model, which may be again provided from the provider system 610 to the customer system 605. The customer system 605 may test this new version of the trained ML model (using its data 630) and may measure the accuracy of the results of this second round of inferences to determine if the KPIs are met or better met. Additional iterations of feedback data, synthetic data improvement, retraining, and re-testing may continue until the customer system determines that the trained ML model generated by the provider system 610 meets the KPI limits or requirements defined for the model. To track such iterations, customer data, feature description data 645, and inference result data 730 may include tags or metadata to identify each respective batch of data and how it maps back to the customer data 630 (e.g., by respective batch ID), among other examples. If KPIs are determined to be met, the customer system 605 may determine that the ML model is production ready and may deploy the finished, trained ML model within a live production environment (e.g., 750) for inferences (e.g., using inference logic 755) on live data (e.g., sensor data). In some implementations, improvement of the ML model may continue even after deployment of the mode on a live system 750, for instance, generating new or supplemental feature description data 645 as new customer data is generated and features discovered, such that new versions of the ML model may be trained using synthetic data based on these new features, among other examples features and techniques.

As an illustrative example, an example customer entity has a dataset, D1, that they do not want to share, but want to be considered in an anomaly detection algorithm they intend to deploy within their system, for instance, to detect damaged pallets or packaging from image data of these pallets. As an example, the dataset D1 includes a set of 1000 digital images collected from camera sensors deployed in a customer warehouse or other facility. The customer may use a feature extractor 640 (e.g., as provided as a tool to the customer by a provider entity solution provider), which is run against the dataset D1 to detect and describe features appearing within the D1 dataset. Feature description data O1 may be generated by the feature extractor to inform the provider system of the characteristics of the D1 dataset, without actually allowing the provider system to access the D1 dataset, thereby maintaining data privacy. The provider system generates a synthetic dataset D2 that has the same characteristics as dataset D1 based on the feature description data O1. The synthetic data may be generated in accordance with various settings which may be set by the provider system and/or the customer system, such as the number of images to generate, define certain objects that images should include (e.g., pallets, boxes, etc.), learning rate, weights, among other settings.

Continuing with this example, a data scientist (associated with the provider system) may develop the desired (and in some cases custom-built) prediction AI algorithm for the customer and cause this model to be trained on the D2 synthetic data and sends the trained algorithm back to the customer for testing. In this example, the customer runs the prediction algorithm against the original dataset D1 and measures the performance (e.g., in terms of accuracy) of the algorithm. As an example, assuming a desired accuracy of at least 90%, but where the resultant measured accuracy of the trained prediction algorithm of only 70%, the customer system may generate feedback data that is fed to the provider system and used to adjust the learning rate, initial weight, and other parameters of the data synthesizer and generate a second version of synthetic data (e.g., dataset D3). The prediction AI algorithm may then be retrained on the D3 dataset before being returned to the customer for an additional round of testing. In another (or additional) approach, the customer data may be fed into the trained version of the algorithm in smaller batches (e.g., 100 image batches), with the KPIs being measured on each batch. Based on the accuracy numbers of each batch, the customer may extract additional features of any of these batches where the KPI numbers are below the threshold limits. The smaller subset of feature may be provided as feature description data to the provider system for use in generating another version of synthetic images (e.g., as supplemental training data, rather than an entirely new set) to fine tune training of the AI algorithm based on only this smaller synthetic data set, among other examples.

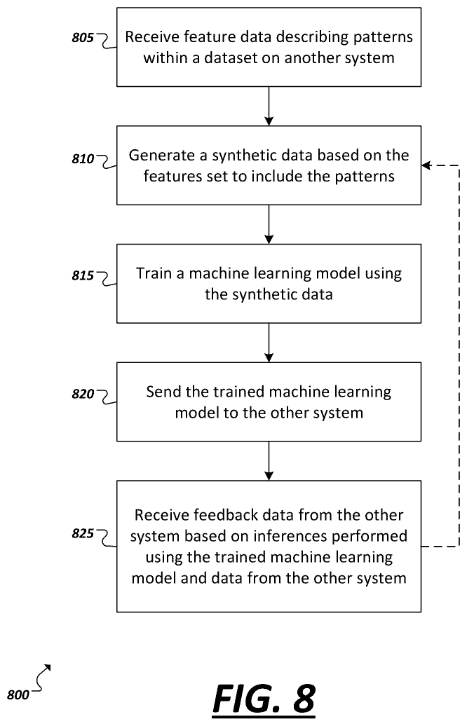

Turning to FIG. 8, a simplified flow diagram 800 is shown of operations of an example provider system, such as described in the examples above. For instance, a provider system may receive feature description data from an independent customer system, for instance, in connection with a request from the customer system to train a particular machine learning model or AI algorithm. The feature description data may include descriptions, copies, or representations of a number of distinct and statistically significant features occurring in the data of the customer, which is withheld from the provider system. The nature of the descriptions and the features may depend not only on the type of data (e.g., image, video, text, audio, timeseries sensor data, etc.), but also the nature of the activities of the customer and their system. A machine learning based (e.g., generative algorithm) may take the feature description data as an input and generate 810 a synthetic data set representing the customer's “real” data set, so as to generate training data that mimics and includes these same features and characteristics. The generation 810 of the synthetic data may be based on various settings of the data synthesizer, which may be adjusted at the direction of the provider system or through requests (e.g., feedback data (e.g., 825)) of the customer system. The provider system trains 815 the machine learning model using the synthetic data set and sends 820 the trained machine learning mode to the customer system. In some implementations, the training 815 of the machine learning model may use not only the synthetic data generated at 810, but may utilize additional synthetic data generated from other feature data (e.g., generated at another customer or using a different feature analysis tool) or generated by a third party, to enhance the training 815 of the machine learning model, among other examples. The customer system may test the trained model using its real data and feedback data may be received 825 from the customer system based on these tests. In some cases, the feedback data may cause or be the basis of enhanced, supplemental, or replacement synthetic data to be generated (based on the information included in the feedback data), which may trigger further training of the machine learning model and one or more multiple iterations of new versions of the trained machine leaning model being sent to the customer system for further testing and ultimate approval.

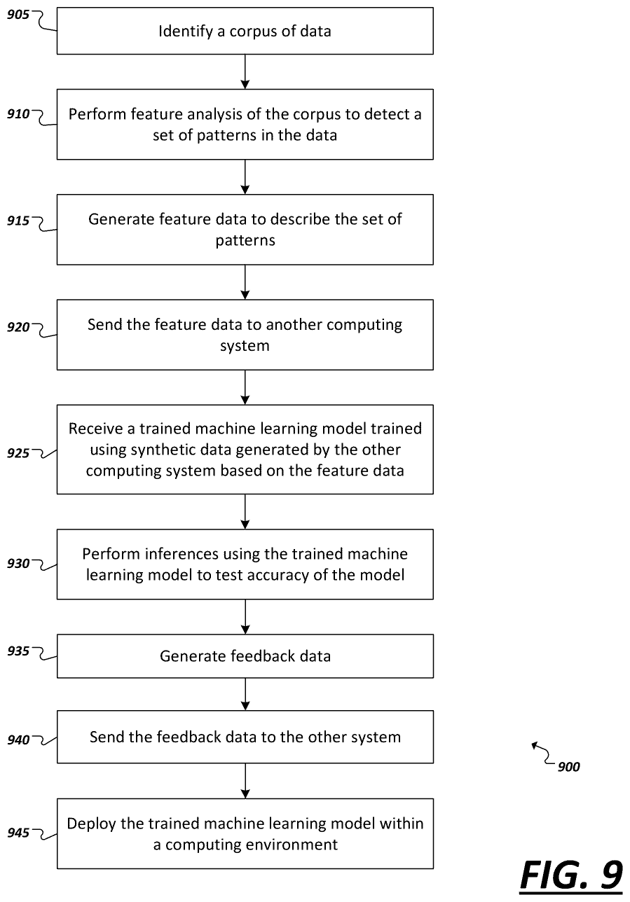

Turning to FIG. 9, a simplified flow diagram 900 is shown of operations of an example customer system, such as described in the examples above. For instance, a corpus of data (or data set) owned by a particular customer entity may be identified 905, securely hosted within the customer system. A feature extractor tool may be utilized within the customer system to perform statistical analysis of the corpus to detect a set of patterns within the data and features (e.g., common text fragments, sentence fragments, image or graphic elements, color blocks, sensor time series values, etc.) corresponding to these patterns. The feature extractor tool executed on the customer system may generate 915 as an output feature description data describing the features detected from the statistical analysis 910. The feature description data is sent 920 in lieu of training data from the customer system (e.g., the corpus of data) to a remote provider system for use by the provider system in generating synthetic training data to train a machine learning model customized to the customer entity. The trained machine learning model is received 925 from the provider system and tested for accuracy by performing inferences 930 on the customer system using data from the corpus of data (or other customer data) to test the quality of the trained model (e.g., based on its accuracy or other key performance metrics set between the customer and provider). The customer system may generate 935 feedback data, which includes the metrics and potentially other information (e.g., additional feature descriptions) and sent 940 to the provider system for use by the provider system in refining the synthetic training data and thereby subsequent iterations of the machine learning model, until the machine learning model meets the performance metrics and deployed 945 within a live customer computing environment.

“Logic”, as used herein, may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is a non-transitory computer-readable storage medium with instructions stored thereon, the instructions executable by a machine to cause the machine to: receive, from a computer system, feature data, where the feature data describes a set of patterns within a dataset hosted on the computer system; generate a synthetic data set based on the feature data, where the synthetic data is to include the set of patterns; train a machine learning model using the synthetic data; and send the trained machine learning model to the computer system for use in inferences run on the computer system.

Example 2 includes the subject matter of example 1, where access to the dataset is restricted and the synthetic data is to model characteristics of the dataset based on the feature data.

Example 3 includes the subject matter of any one of examples 1-2, where the instructions are executable to further cause the machine to: receive feedback data from the computer system based on the inferences run on the computer system; generate new synthetic data based on the feedback data; train the machine learning model using the new synthetic data to generated a new trained version of the machine learning model; and send the new trained version of the machine learning model to the computer system.

Example 4 includes the subject matter of example 3, where the feedback data includes additional feature data, where the additional feature data describes additional patterns to be considered beyond the set of patterns included in the feature data, and the new synthetic data is generated to include the set of patterns and additional patterns.

Example 5 includes the subject matter of any one of examples 3-4, where the instructions are executable to further cause the machine to change settings used in generation of synthetic data based on the feedback data, and the new synthetic data is generated from the feature data based on the changed settings.

Example 6 includes the subject matter of any one of examples 1-5, where the synthetic data includes a first version of the synthetic data, and the instructions are executable to further cause the machine to: determine, for the set of patterns, whether a representation of a respective pattern in the set of patterns is accurately represented in the first version of the synthetic data; generate comparator data to indicate that the representation of at least a particular pattern in the set of patterns is inadequately represented in the first version of the synthetic data; and use the comparator data to generate a second version of the synthetic data, where the second version of the synthetic data is used to train the machine learning model.

Example 7 includes the subject matter of any one of examples 1-6, where the synthetic data is generated through an artificial intelligence algorithm using the feature data as an input.

Example 8 includes the subject matter of any one of examples 1-7, where the machine learning model includes one of a predictive model, a forecasting model, or a classification model.

Example 9 includes the subject matter of any one of examples 1-8, where the dataset includes image data or video data, and the set of features includes a set of graphical features recurring at statistically significant frequencies within the image data or video data.

Example 10 includes the subject matter of any one of examples 1-8, where the dataset includes text data, and the set of features includes one or more of recurring letter patterns, recurring word patterns, or recurring sentence fragments within the text data.

Example 11 includes the subject matter of any one of examples 1-8, where the dataset includes time series sensor data, and the set of features correspond to patterns recurring at statistically significant frequencies within the time series sensor data.

Example 12 is a non-transitory computer-readable storage medium with instructions stored thereon, the instructions executable by a machine to cause the machine to: identify a dataset within a corpus of data hosted on a first computing system; perform a statistical analysis on the dataset to detect a set of patterns in the dataset; generate feature data from the statistical analysis to describe a set of features within the dataset based on the set of patterns; send the feature data to a second computing system; receive a trained machine learning model from the second computing system, where the trained machine learning model is trained by the second computing system using synthetic data generated on the second computing system based on the feature data; provide input data from the corpus of data to the trained machine learning model to perform inferences based on the input data; and determine a degree of accuracy of the trained machine learning model based on the inferences.

Example 13 includes the subject matter of example 12, where the instructions are executable to further cause the machine to send the feature data with a request to develop the trained machine learning model at the second computing system, and access to the corpus of data is withheld from the second computing system.

Example 14 includes the subject matter of any one of examples 12-13, where the instructions are executable to further cause the machine to: generate feedback data based on results of the inferences; send the feedback data to the second computing system; and receive a new version of the trained machine learning model generated by the second computing system based on the feedback data.

Example 15 includes the subject matter of example 14, where the instructions are executable to further cause the machine to: determine that a particular one of the inferences based on particular data in the corpus of data was inaccurate; and detect one or more features in the particular data, where the feedback data describes the one or more features to be used in a new version of the synthetic data generated by the second computer system, where the new version of the synthetic data is to be used in training of the new version of the trained machine learning model.

Example 16 includes the subject matter of any one of examples 14-15, where the instructions are executable to further cause the machine to determine whether the inferences meet a set of key performance indicators (KPIs) for the machine learning model, where the feedback data identifies the degree to which the inferences met the set of KPIs.

Example 17 includes the subject matter of any one of examples 14-16, where the feedback data is to change settings of a data synthesizer executed by the second computing device to generate the synthetic data.

Example 18 includes the subject matter of any one of examples 12-17, where the dataset includes image data or video data, and the set of features includes a set of graphical features recurring at statistically significant frequencies within the image data or video data.

Example 19 includes the subject matter of any one of examples 12-17, where the dataset includes text data, and the set of features includes one or more of recurring letter patterns, recurring word patterns, or recurring sentence fragments within the text data.

Example 20 includes the subject matter of any one of examples 12-17, where the dataset includes time series sensor data, and the set of features correspond to patterns recurring at statistically significant frequencies within the time series sensor data.

Example 21 includes the subject matter of any one of examples 12-20, where the machine learning model includes one of a predictive model, a forecasting model, or a classification model.

Example 22 is a system including: a first computing system including: one or more first data processors; a data store to store a dataset; a feature extraction tool, executable by the one or more first data processors to perform a statistical analysis of the dataset to generate feature description data to described a set of features within the dataset; and a second computing system coupled to the first computing system by a network, where the dataset is inaccessible to the second computing system, and the second computing includes: a data synthesizer, executable by the one or more second data processors to: receive the feature description data; and generate a synthetic dataset based on the feature description data, where the synthetic dataset models the dataset and is to include the set of features; and a model trainer, executable by the one or more second data processors to: train a machine learning model with the synthetic data set to generate a trained machine learning model, where the machine learning model is for use by the first computing system and is to use data from the data store as an input.

Example 23 includes the subject matter of example 22, where the first computing system further includes: an inference engine, executable by the one or more first data processors to use the trained machine learning model to perform inferences on data in the corpus of data; and a results analyzer, executable by the one or more first data processors to: determine from the inferences whether the machine learning model meets a set of key performance indicators for the machine learning model; and send feedback data to the second computing system to indicate how the machine learning model meets or does not meet the key performance indicators.

Example 24 includes the subject matter of example 23, where the data synthesizer is further executable to: receive the feedback data from the first computer system based on the inferences run on the first computer system; generate new synthetic data based on the feedback data; train the machine learning model using the new synthetic data to generated a new trained version of the machine learning model; and send the new trained version of the machine learning model to the computer system.

Example 25 includes the subject matter of example 24, where the feedback data includes additional feature data, where the additional feature data describes additional patterns to be considered beyond the set of patterns included in the feature data, and the new synthetic data is generated to include the set of patterns and additional patterns.

Example 26 includes the subject matter of any one of examples 24-25, where the data synthesizer is further executable to change settings used in generation of synthetic data based on the feedback data, and the new synthetic data is generated from the feature data based on the changed settings.

Example 27 includes the subject matter of any one of examples 22-26, where access to the dataset is restricted and the synthetic data is to model characteristics of the dataset based on the feature data.

Example 28 includes the subject matter of any one of examples 22-27, where the feature extraction tool is provided to the first computing system by the second computing system in association with training of the machine learning model.

Example 29 includes the subject matter of any one of examples 22-28, where the second computing further includes a data comparator executable by the one or more second data processors to: determine, for the set of patterns, whether a representation of a respective pattern in the set of patterns is accurately represented in the first version of the synthetic data; generate comparator data to indicate that the representation of at least a particular pattern in the set of patterns is inadequately represented in the first version of the synthetic data; and use the comparator data to generate a second version of the synthetic data, where the second version of the synthetic data is used to train the machine learning model.

Example 30 includes the subject matter of any one of examples 22-29, where the synthetic data is generated through an artificial intelligence algorithm using the feature data as an input.

Example 31 includes the subject matter of any one of examples 22-30, where the machine learning model includes one of a predictive model, a forecasting model, or a classification model.

Example 32 includes the subject matter of any one of examples 22-31, where the dataset includes image data or video data, and the set of features includes a set of graphical features recurring at statistically significant frequencies within the image data or video data.

Example 33 includes the subject matter of any one of examples 22-31, where the dataset includes text data, and the set of features includes one or more of recurring letter patterns, recurring word patterns, or recurring sentence fragments within the text data.

Example 34 includes the subject matter of any one of examples 22-31, where the dataset includes time series sensor data, and the set of features correspond to patterns recurring at statistically significant frequencies within the time series sensor data.

Example 35 is a method including: receive, from a computer system, feature data, where the feature data describes a set of patterns within a dataset hosted on the computer system; generate a synthetic data set based on the feature data, where the synthetic data is to include the set of patterns; train a machine learning model using the synthetic data; and send the trained machine learning model to the computer system for use in inferences run on the computer system.

Example 36 includes the subject matter of example 35, where access to the dataset is restricted and the synthetic data is to model characteristics of the dataset based on the feature data.

Example 37 includes the subject matter of any one of examples 35-36, further including: receiving feedback data from the computer system based on the inferences run on the computer system; generating new synthetic data based on the feedback data; training the machine learning model using the new synthetic data to generate a new trained version of the machine learning model; and sending the new trained version of the machine learning model to the computer system.

Example 38 includes the subject matter of example 37, where the feedback data includes additional feature data, where the additional feature data describes additional patterns to be considered beyond the set of patterns included in the feature data, and the new synthetic data is generated to include the set of patterns and additional patterns.

Example 39 includes the subject matter of any one of examples 37-38, further including changing settings used in generation of synthetic data based on the feedback data, and the new synthetic data is generated from the feature data based on the changed settings.

Example 40 includes the subject matter of any one of examples 36-39, where the synthetic data includes a first version of the synthetic data, and the method further includes: determining, for the set of patterns, whether a representation of a respective pattern in the set of patterns is accurately represented in the first version of the synthetic data; generating comparator data to indicate that the representation of at least a particular pattern in the set of patterns is inadequately represented in the first version of the synthetic data; and using the comparator data to generate a second version of the synthetic data, where the second version of the synthetic data is used to train the machine learning model.

Example 41 includes the subject matter of any one of examples 36-40, where the synthetic data is generated through an artificial intelligence algorithm using the feature data as an input.

Example 42 includes the subject matter of any one of examples 36-41, where the machine learning model includes one of a predictive model, a forecasting model, or a classification model.

Example 43 includes the subject matter of any one of examples 36-42, where the dataset includes image data or video data, and the set of features includes a set of graphical features recurring at statistically significant frequencies within the image data or video data.

Example 44 includes the subject matter of any one of examples 36-43, where the dataset includes text data, and the set of features includes one or more of recurring letter patterns, recurring word patterns, or recurring sentence fragments within the text data.

Example 45 includes the subject matter of any one of examples 36-44, where the dataset includes time series sensor data, and the set of features correspond to patterns recurring at statistically significant frequencies within the time series sensor data.

Example 46 is a system including means to perform the method of any one of examples 36-45.

Example 47 is a method including: identifying a dataset within a corpus of data hosted on a first computing system; performing a statistical analysis on the dataset to detect a set of patterns in the dataset; generating feature data from the statistical analysis to describe a set of features within the dataset based on the set of patterns; sending the feature data to a second computing system; receiving a trained machine learning model from the second computing system, where the trained machine learning model is trained by the second computing system using synthetic data generated on the second computing system based on the feature data; providing input data from the corpus of data to the trained machine learning model to perform inferences based on the input data; and determining a degree of accuracy of the trained machine learning model based on the inferences.

Example 48 includes the subject matter of example 47, further including sending the feature data with a request to develop the trained machine learning model at the second computing system, and access to the corpus of data is withheld from the second computing system.

Example 49 includes the subject matter of any one of examples 47-48, further including: generating feedback data based on results of the inferences; sending the feedback data to the second computing system; and receiving a new version of the trained machine learning model generated by the second computing system based on the feedback data.

Example 50 includes the subject matter of example 49, further including: determining that a particular one of the inferences based on particular data in the corpus of data was inaccurate; detecting one or more features in the particular data, where the feedback data describes the one or more features to be used in a new version of the synthetic data generated by the second computer system, where the new version of the synthetic data is to be used in training of the new version of the trained machine learning model.

Example 51 includes the subject matter of any one of examples 49-50, further including determining whether the inferences meet a set of key performance indicators (KPIs) for the machine learning model, where the feedback data identifies the degree to which the inferences met the set of KPIs.

Example 52 includes the subject matter of any one of examples 49-51, where the feedback data is to change settings of a data synthesizer executed by the second computing device to generate the synthetic data.

Example 53 includes the subject matter of any one of examples 46-51, where the dataset includes image data or video data, and the set of features includes a set of graphical features recurring at statistically significant frequencies within the image data or video data.

Example 54 includes the subject matter of any one of examples 47-53, where the dataset includes text data, and the set of features includes one or more of recurring letter patterns, recurring word patterns, or recurring sentence fragments within the text data.

Example 55 includes the subject matter of any one of examples 47-54, where the dataset includes time series sensor data, and the set of features correspond to patterns recurring at statistically significant frequencies within the time series sensor data.

Example 56 includes the subject matter of any one of examples 47-55, where the machine learning model includes one of a predictive model, a forecasting model, or a classification model.

Example 57 is a system comprising means to perform the method of any one of examples 47-56.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A non-transitory computer-readable storage medium with instructions stored thereon, the instructions executable by a machine to cause the machine to:
receive, from a computer system, feature data, wherein the feature data describes a set of patterns within a dataset hosted on the computer system;
generate a synthetic data set based on the feature data, wherein the synthetic data is to include the set of patterns;
train a machine learning model using the synthetic data; and
send the trained machine learning model to the computer system for use in inferences run on the computer system.

2. The storage medium of claim 1, wherein access to the dataset is restricted and the synthetic data is to model characteristics of the dataset based on the feature data.

3. The storage medium of claim 1, wherein the instructions are executable to further cause the machine to:
receive feedback data from the computer system based on the inferences run on the computer system;
generate new synthetic data based on the feedback data;
train the machine learning model using the new synthetic data to generated a new trained version of the machine learning model; and
send the new trained version of the machine learning model to the computer system.

4. The storage medium of claim 3, wherein the feedback data comprises additional feature data, wherein the additional feature data describes additional patterns to be considered beyond the set of patterns included in the feature data, and the new synthetic data is generated to include the set of patterns and additional patterns.

5. The storage medium of claim 3, wherein the instructions are executable to further cause the machine to change settings used in generation of synthetic data based on the feedback data, and the new synthetic data is generated from the feature data based on the changed settings.

6. The storage medium of claim 1, wherein the synthetic data comprises a first version of the synthetic data, and the instructions are executable to further cause the machine to:
determine, for the set of patterns, whether a representation of a respective pattern in the set of patterns is accurately represented in the first version of the synthetic data; and
generate comparator data to indicate that the representation of at least a particular pattern in the set of patterns is inadequately represented in the first version of the synthetic data; and
use the comparator data to generate a second version of the synthetic data, wherein the second version of the synthetic data is used to train the machine learning model.

7. The storage medium of claim 1, wherein the synthetic data is generated through an artificial intelligence algorithm using the feature data as an input.

8. The storage medium of claim 1, wherein the machine learning model comprises one of a predictive model, a forecasting model, or a classification model.

9. A non-transitory computer-readable storage medium with instructions stored thereon, the instructions executable by a machine to cause the machine to:
identify a dataset within a corpus of data hosted on a first computing system;
perform a statistical analysis of the dataset to detect a set of patterns in the dataset;
generate feature data from the statistical analysis to describe a set of features within the dataset based on the set of patterns;
send the feature data to a second computing system;
receive a trained machine learning model from the second computing system, wherein the trained machine learning model is trained by the second computing system using synthetic data generated on the second computing system based on the feature data;
provide input data from the corpus of data to the trained machine learning model to perform inferences based on the input data; and
determine a degree of accuracy of the trained machine learning model based on the inferences.

10. The storage medium of claim 9, wherein the instructions are executable to further cause the machine to send the feature data with a request to develop the trained machine learning model at the second computing system, and access to the corpus of data is withheld from the second computing system.

11. The storage medium of claim 9, wherein the instructions are executable to further cause the machine to:
generate feedback data based on results of the inferences;
send the feedback data to the second computing system; and
receive a new version of the trained machine learning model generated by the second computing system based on the feedback data.

12. The storage medium of claim 11, wherein the instructions are executable to further cause the machine to:
determine that a particular one of the inferences based on particular data in the corpus of data was inaccurate; and
detect one or more features in the particular data, wherein the feedback data describes the one or more features to be used in a new version of the synthetic data generated by the second computer system, wherein the new version of the synthetic data is to be used in training of the new version of the trained machine learning model.

13. The storage medium of claim 11, wherein the instructions are executable to further cause the machine to determine whether the inferences meet a set of key performance indicators (KPIs) for the machine learning model, wherein the feedback data identifies the degree to which the inferences met the set of KPIs.

14. The storage medium of claim 11, wherein the feedback data is to change settings of a data synthesizer executed by the second computing device to generate the synthetic data.

15. The storage medium of claim 9, wherein the dataset comprises image data or video data, and the set of features comprises a set of graphical features recurring at statistically significant frequencies within the image data or video data.

16. The storage medium of claim 9, wherein the dataset comprises text data, and the set of features comprises one or more of recurring letter patterns, recurring word patterns, or recurring sentence fragments within the text data.

17. The storage medium of claim 9, wherein the dataset comprises time series sensor data, and the set of features correspond to patterns recurring at statistically significant frequencies within the time series sensor data.

18. A system comprising:
a first computing system comprising:
one or more first data processors;
a data store to store a dataset; and
a feature extraction tool, executable by the one or more first data processors to perform a statistical analysis of the dataset to generate feature description data to describe a set of features within the dataset; and
a second computing system coupled to the first computing system by a network, wherein the dataset is inaccessible to the second computing system, and the second computing comprises:
a data synthesizer, executable by the one or more second data processors to:
receive the feature description data; and
generate a synthetic dataset based on the feature description data, wherein the synthetic dataset models the dataset and is to include the set of features; and
a model trainer, executable by the one or more second data processors to:
train a machine learning model with the synthetic data set to generate a trained machine learning model, wherein the trained machine learning model is for use by the first computing system and is to use data from the data store as an input.

19. The system of claim 18, wherein the first computing system further comprises:
an inference engine, executable by the one or more first data processors to use the trained machine learning model to perform inferences on data in the corpus of data; and
a results analyzer, executable by the one or more first data processors to:
determine from the inferences whether the machine learning model meets a set of key performance indicators for the machine learning model; and
send feedback data to the second computing system to indicate how the machine learning model meets or does not meet the key performance indicators.

20. The system of claim 18, wherein the feature extraction tool is provided to the first computing system by the second computing system in association with training of the machine learning model.
